(19) United States
(12) Patent Application Publication
(10) Pub. No.: US 2004/0011396 A1
(43) Pub. Date: Jan. 22, 2004

(54) Tubing connection system comprising tubing coding

(76) Inventor: Jorg Zwirner, Gaulfelden (DE)

Correspondence Address: Corporate Patent Counsel, Philips Electronics North America Corporation, 580 White Plains Road, Tarrytown, NY, 10591, US

(21) Appl. No.: 10/398,045

(22) PCT Filed: Apr. 3, 2002
(86) PCT No.: PCT/IB02/01045

(30) Foreign Application Priority Data
Apr. 3, 2001 (DE) 10116566.8

(51) Int. Cl. F17D 3/00; F17D 1/00; E03B 1/00

(52) U.S. Cl. 137/1

(57) ABSTRACT

A tube system for propagating gaseous or liquid substances from a first tube (70) to a second tube (80) or vice versa includes a first connection (20) with a first connection element (40) which is to be contacted by the first tube (70) and a second connection (30) with a second connection element (60) which is to be contacted by the second tube (80). The outer diameter of the first connection element (40) is smaller than that of the second connection element (60). The inner diameter of the first tube (70) is slightly smaller than the outer diameter of the first connection element (40) and the inner diameter of the second tube (80) is slightly smaller than the outer diameter of the second connection element (60). Preferably, the first connection (20) also includes an outer diameter limiter (50), the inner diameter of the outer diameter limiter (50) being smaller than the outer diameter of the second tube (80) but larger than the outer diameter of the first tube (70).

### BACKGROUND OF THE INVENTION

The present invention relates to a tube connection system which includes a first connection which is to be contacted by a first tube and a second connection which is to be contacted by a second tube.

For many applications, notably in the medical field, tubes must be pushed onto connections or be attached thereto in another manner (for example, by screwing). Liquids or gases are then transported, for example, to or from an apparatus via such tubes.

A typical example in the medical field is formed by a gas sensor in which a gas (for example, an anaesthetic gas or a respiratory gas) must first be transported to and subsequently discharged from an apparatus provided with a gas sensor system.

If the flow direction of the gas or the liquid is of importance, it must be ensured that the gas or the liquid is indeed supplied in the flow direction at the inlet of the apparatus and that the gas or the liquid is appropriately discharged again at the outlet of the apparatus.

However, mixing up of the inlet direction and the outlet direction will not necessarily be recognized as an error in a variety of applications such as in medical gas sensors. In that case the apparatus will carry out a measurement, but the measurement values will be incorrect.

### SUMMARY OF THE INVENTION

It is an object of the present invention to ensure that the mixing up of the inlet direction and the outlet direction or, generally speaking, the mixing up of two tubes for connection to connection elements is avoided for applications in which the flow direction of the gas or the liquid is of importance.

This object is achieved in conformity with the characterizing part of the independent claims. Advantageous embodiments are disclosed in the dependent claims.

In conformity with the present invention the tubes are provided with different inner diameters and the associated connections are provided with corresponding external diameters in order to ensure that the connections or the tubes cannot be mixed up. By suitably proportioning the diameters it can be achieved that contacting without applying an excessive force is possible only if the tubes suitably match the connections. The connection of tubes to an apparatus in the correct flow direction can thus be ensured by coding the diameters of the tubes and utilizing a corresponding configuration of the associated connections.

The coding in accordance with the invention does not require additional elements for securing the connection and no additional work is required either for mounting. The connection positions are clearly recognizable prior to mounting. The inner diameters of the tubes can be selected at random and may also be chosen so as to be equally large, for example, if necessary from a flow-technical point of view.

Overall, a very economical solution is thus obtained in combination with a simple and clear geometry.

However, in order to effectively ensure not only correct connection of the tubes, but also that incorrect connection cannot be realized by force, a preferred embodiment of the invention is also provided with an outer diameter limiter for one of the tubes to be contacted. Not only correct connection is thus promoted, but incorrect connection is also precluded or at least avoided as well as possible. A practically absolute protection against the mixing up of the tubes can thus be achieved.

Preferably, a tube having a larger outer diameter is prevented from being pushed onto or otherwise attached to a connection having a smaller outer diameter by means of an outer ring provided on this connection. To this end, the inner diameter of the outer ring is chosen so as to be smaller than the outer diameter of the thicker tube.

Preferably, in order to limit the outer diameter use is also made of already present structural elements, since such use again leads to economical solutions.

### BRIEF DESCRIPTION OF THE DRAWINGS

The invention will be described in detail hereinafter with reference to the accompanying drawings in which corresponding references relate to functionally identical or similar features.

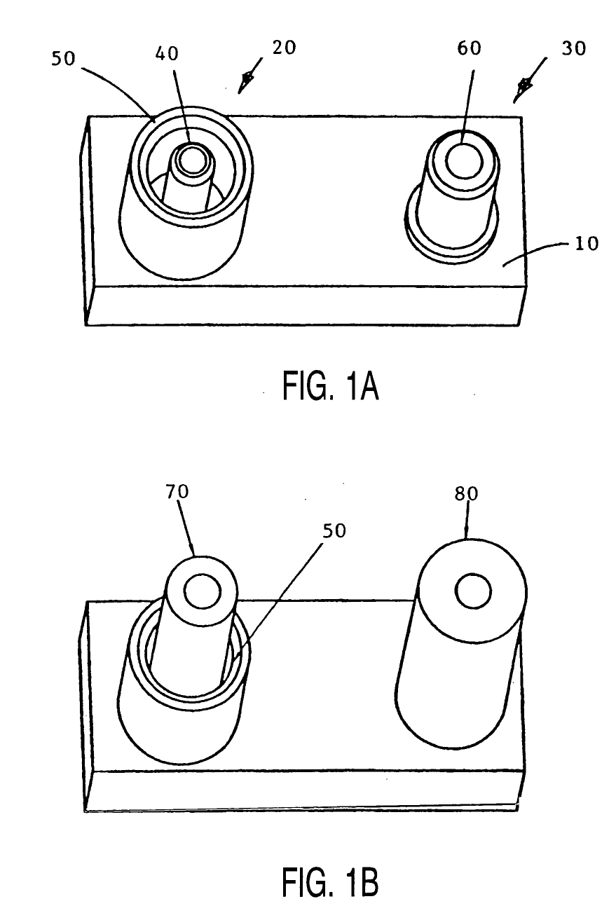

The FIGS. 1A and 1B show a tube coding in accordance with the invention.

### DETAILED DESCRIPTION OF THE DRAWINGS

FIG. 1A shows two tube connections 20 and 30 provided on an apparatus 10. The first connection 20 includes a nipple 40 and an outer diameter limiter 50. The second connection 30, however, includes merely a nipple 60 but no outer diameter limiter.

The two nipples 40 and 60 are constructed so as to be tubular so that the interior is hollow and suitable for propagating or receiving gaseous or liquid substances. The outer diameter of the nipple 40 is chosen to be substantially smaller than the outer diameter of the nipple 60. The inner diameter (or the tube diameter) of the nipples 40 and 60 can be chosen at will and may also be the same.

FIG. 1B shows the apparatus 10 with the two tube connections 20 and 30 of FIG. 1A; however, in FIG. 1B a first tube 70 has been pushed onto the first connection 20 and a second tube 80 onto the second connection 30. The two tubes 70 and 80 mask the two tube connections 20 and 30 in FIG. 1B.

The inner diameter of the first tube 70 is chosen so as to be slightly smaller than the outer diameter of the first nipple 40 of the connection 20, so that the first tube 70 is form-fitted to the first nipple 40. Similarly, the inner diameter of the second tube 80 is chosen so as to be slightly smaller than the outer diameter of the second nipple 60, so that the second tube 80 is also form-fitted to the second nipple 60. The inner diameter of the tubes 70 and 80, however, may also be the same if necessary from a flow-technical point of view.

It need not be elaborated herein that instead of a form-fit any other method of securing, for example, by screwing, by way of a bayonet connection and the like, can also be used.

In order to ensure that the second tube 80 cannot be pushed onto the smaller first nipple 40, the outer diameter of the second tube 80 is chosen so as to be such that it is (not only slightly) larger than the inner diameter of the outer diameter limiter 50. The outer diameter of the first tube 70, however, is chosen so as to be smaller than the inner diameter of the outer diameter limiter 50, so that the first tube readily fits within the outer diameter limiter 50.

1. A tube connection system which includes:
a first connection (20) with a first connection element (40) which is to be contacted by a first tube (70), and a second connection (30) with a second connection element (60) which is to be contacted by a second tube (80), characterized in that the outer diameter of the first connection element (40) is smaller than that of the second connection element (60), the inner diameter of the first tube (70) being slightly smaller than the outer diameter of the first connection element (40) and the inner diameter of the second tube (80) being slightly smaller than the outer diameter of the second connection element (60).

2. A tube connection system as claimed in claim 1, characterized in that the first connection (20) also includes an outer diameter limiter (50), the inner diameter of the outer diameter limiter (50) being smaller than the outer diameter of the second tube (80) but larger than the outer diameter of the first tube (70).

3. A tube connection system as claimed in claim 1 or 2, characterized in that the first connection element (40) and the second connection element (60) are constructed so as to be tubular so that their interior is hollow and suitable for propagating or receiving gaseous or liquid substances.

4. A tube system for propagating gaseous or liquid substances from a first tube (70) to a second tube (80) or vice versa, which system includes:
a first connection (20) with a first connection element (40) which is to be contacted by the first tube (70), and a second connection (30) with a second connection element (60) which is to be contacted by the second tube (80), characterized in that the outer diameter of the first connection element (40) is smaller than that of the second connection element (60), the inner diameter of the first tube (70) being slightly smaller than the outer diameter of the first connection element (40) and the inner diameter of the second tube (80) being slightly smaller than the outer diameter of the second connection element (60).

5. A tube system as claimed in claim 4, characterized in that the first connection (20) also includes an outer diameter limiter (50), the inner diameter of the outer diameter limiter (50) being smaller than the outer diameter of the second tube (80) but larger than the outer diameter of the first tube (70).

6. A tube connection system which includes:
a first connection (20) with a first connection element (40) which is to be contacted by a first tube (70) having a first outer diameter, and a second connection (30) with a second connection element (60) which is to be contacted by a second tube (80) having a second outer diameter, the second outer diameter being larger than the first outer diameter, characterized in that the first connection (20) also includes an outer diameter limiter (50), the inner diameter of the outer diameter limiter (50) being smaller than the second outer diameter but larger than the first outer diameter.

7. A tube system for propagating gaseous or liquid substances from a first tube (70), having a first outer diameter, to a second tube (80), having a second outer diameter, or vice versa, which system includes:
a first connection (20) with a first connection element (40) which is to be contacted by the first tube (70), and a second connection (30) with a second connection element (60) which is to be contacted by the second tube (80), the second outer diameter being larger than the first outer diameter, characterized in that the first connection (20) also includes an outer diameter limiter (50), the inner diameter of the outer diameter limiter (50) being smaller than the second outer diameter but larger than the first outer diameter.
